(19) United States
(12) Patent Application Publication
(10) Pub. No.: US 2006/0115222 A1
(43) Pub. Date: Jun. 1, 2006

(54) Optical cable having high compression resistance

(75) Inventors: Kyung-Tae Park, Gumi-si (KR); Jin-Han Kim, Gumi-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/224,411

(22) Filed: Sep. 12, 2005

(30) Foreign Application Priority Data
Nov. 26, 2004 (KR) 2004-98176

(51) Int. Cl. G02B 6/44

(52) U.S. Cl. 385/110; 385/113

(57) ABSTRACT

An optical cable having high compression resistance includes a core, a central strength member, at least one light transmission medium, at least one supporting member, and a first sheath. The core has an opening at its center and at least one slot at its circumference. The central strength member is inserted into the opening. The light transmission medium is arranged inside the slot. At least a portion of the supporting member is arranged inside the slot to support inner walls of the slot that are located opposite to each other. The first sheath surrounds the core.

### CLAIM OF PRIORITY

This application claims priority under 35 U.S.C. § 119 to an application entitled “Slot Type Optical Cable Having High Compression Resistance,” filed in the Korean Intellectual Property Office on Nov. 26, 2004 and assigned Serial No. 2004-98176, the contents of which are incorporated herein by reference.

### BACKGROUND OF THE INVENTION

1. Field of the Invention

The present invention generally relates to an optical cable and in particular, to a slot type optical cable having a core and a plurality of slots on its circumference.

2. Description of the Related Art

An optical cable is typically installed by laying an optical cable in a duct installed already under the ground or directly burying the optical cable under the ground. Alternatively, the optical cable is installed in the air using an electric pole.

As direct burying and installation of the optical cable in a duct require digging of the ground, it takes longer and costly. Similarly, the installation of the optical cable in the air requires installation of the electric pole which takes longer and costly.

Further, the optical cable can also be installed directly on the ground, e.g., using gravel around a railroad. Such installation is advantageous over the above-mentioned installation methods in that it requires low installation cost and short construction time. However, to install an optical cable directly on the ground, the optical cable must have high compression resistance against load from a heavy object, such as a tracked vehicle used for railway maintenance. In addition, with the advance in a rapid transit railway, it is preferable that the optical cable has an insulation structure to prevent the accidental occurrence of an electric contact at a voltage of about 25 kV.

One of the known optical cable, a slot type optical cable has a core having slots on its circumference, tubes inside the slots, and optical fibers in the tubes. The slot type optical cable has high compression resistance when compared to other types of optical cables, but its compression resistance is not high enough for the installation on the ground. That is, if heavy external pressure is applied to the slot type optical cable, the slots may be deformed and the deformed slots may press the tubes and the optical fibers inside the tubes, causing an optical loss.

Therefore, there is a need for an improved slot type optical cable whose compression resistance is adequate enough for the installation on the ground.

### SUMMARY OF THE INVENTION

The present invention provides a slot type optical cable whose compression resistance is high enough for installation on the ground.

In one embodiment, there is provided an optical cable having high compression resistance. The optical cable includes a core, a central strength member, at least one light transmission medium, at least one supporting member, and a first sheath. The core has an opening at its center and at least one slot at its circumference. The central strength member is inserted into the opening. The light transmission medium is arranged inside the slot. At least a portion of the supporting member is arranged inside the slot to support inner walls of the slot that are located opposite to each other. The first sheath surrounds the core.

### BRIEF DESCRIPTION OF THE DRAWINGS

The above features and advantages of the present invention will become more apparent from the following detailed description when taken in conjunction with the accompanying drawings in which:

FIG. 1 illustrates a slot type optical cable having high compression resistance according to an embodiment of the present invention;

FIG. 2 illustrates a core shown in FIG. 1; and

FIG. 3 illustrates a method of securing insulation when the slot type optical cable shown in FIG. 1 is installed in an area prone to an electrical danger.

### DETAILED DESCRIPTION

An embodiment of the present invention will now be described in detail with reference to the annexed drawings. For the purposes of clarity and simplicity, a detailed description of known functions and configurations incorporated herein has been omitted for conciseness.

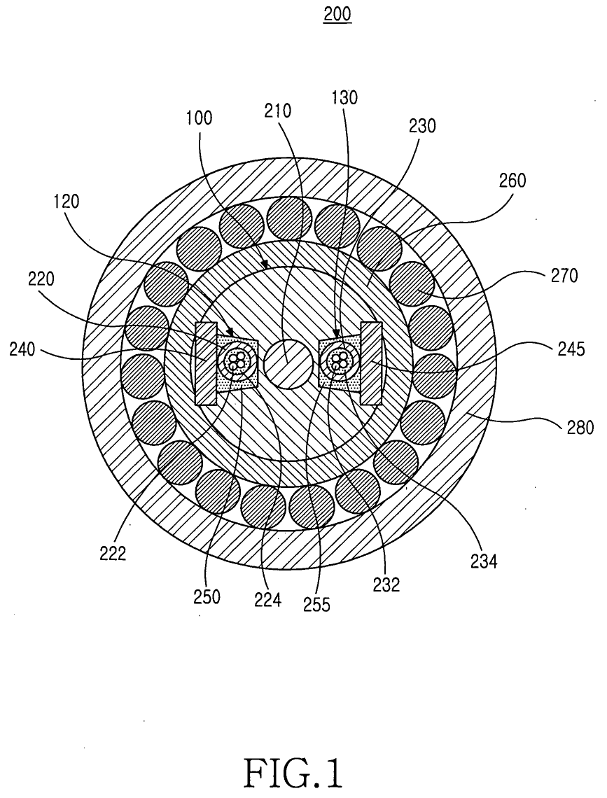

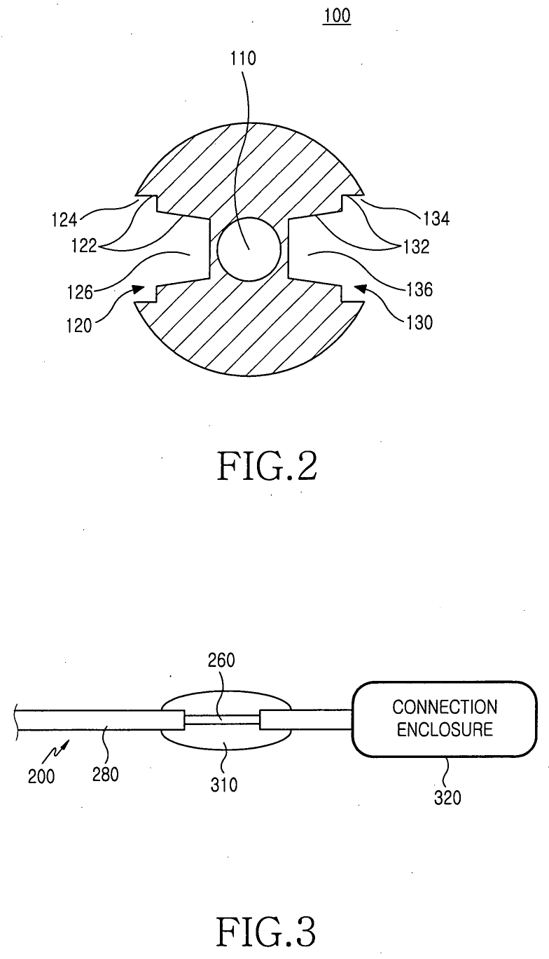

FIG. 1 illustrates a slot type optical cable having high compression resistance according to an embodiment of the present invention. FIG. 2 illustrates a core shown in FIG. 2.

Referring to FIG. 1, a slot type optical cable 200 according to the invention includes a core 100, a central strength member (CSM) 210, a first tube 220 and a second tube 230, optical fibers 222 and 232 that serve as a light transmission media, a first supporting member 240 and a second supporting member 245, a first sheath 260, outer strength members 270, and a second sheath 280.

Referring to FIG. 2, the core 100 takes the form of a cylindrical rod and has a cylindrical opening 110 at its center and the first and second slots 120 and 130 on its circumference. Each of the first and second slots 120 and 130 has a 2-layer structure in which a first layer 124 (134) is formed to have predetermined depth and width towards the center of the core 100 from the circumference of the core 100, and a second layer 126 (136) is formed to have predetermined depth and width towards the center of the core 100 from the bottom surface of the first layer 124 (134). The width of the second layer 126 (136) is smaller than that of the first layer 124 (134), and the depth of the second layer 126 (136) is larger than that of the first layer 124 (134). The first layer 124 or 134 takes the form of a rectangular groove, and the second layer 126 (136) takes the form of a trapezoidal groove. Each of the slots 120 and 130 is extended along the longitudinal direction of the core 100. The core 100 is made of a non-metallic material, e.g., polyvinyl chloride (PVC), polyvinylidene fluoride (PVDF), and fiber-reinforced plastic (FRP).

The CSM 210 takes the form of a cylindrical rod and is inserted into the opening 110 of the core 100 to reinforce the tensile strength of the core 100. The CSM 210 has a diameter not lower than 50% of the bottom width of the slot 120 (or 130), i.e., a bottom width of the slot 126 (136). The CSM 210 may be made of a metallic material such as aluminum or a non-metallic material such as fiber-reinforced plastic (FRP).

The tube 220 (230) is placed on the slot 120 (130) and has mounted therein a light transmission media. The tube 220 (230) takes a hollow cylindrical shape having a central opening, and the plurality of optical fibers 222 (232) are mounted in the opening of the tube 220 (230). A jelly compound 224 (234) is filled in the hollow internal space of the tube 220 (230) and serves to block moisture penetrated into the tube 220 (230). In addition to optical fibers, the light transmission media may include optical fiber ribbons. The tube 220 (230) may be made of a non-metallic material such as polycarbonate (PC) and settled on the bottom surface of the second layer 126 (136) of the slot 120 (130). The depth of the second layer 126 (136) is set larger than the diameter of the tube 220 (230).

At least a portion of the supporting member 240 (245) is placed inside the slot 120 (130) to support an inner side wall 122 (132) of the slot 120 (130). Herein, the inner side walls 122 (132) are located at opposite end from each other. The supporting member 240 (245) takes the form of a rectangular block and is inserted between the opposite inner side walls 122 (132) of the first layer 124 (134). The supporting member 240 (245) may be made of a metallic material such as aluminum or a non-metallic material such as PVC. Since the supporting member 240 (245) supports the opposite inner side walls 122 (132) of the slot 120 (130), deformation of the slot 120 (130) can be prevented when external pressure is applied to the core 100. The hollow internal space of the slot 120 (130) is filled with a water swellable member 250 (255), such as water swellable yarn, water swellable tape, or jelly compound.

The first sheath 260 surrounds the core 100 and is formed through an extrusion process. The first sheath 260 is made of a plastic material, e.g., polyethylene (PE) or ethylene vinylacetate copolymer (EVA).

To provide tensile strength, the outer strength members 270 are arranged around the first sheath 260 in the form of a straight line or wound around the first sheath 260 spirally or using an S-Z winding method. The outer strength members 270 may be made of a non-metallic material such as aramid yam or glass yam or a metallic material such as a steel wire.

The second sheath 280 is located at the outermost part of the slot type optical cable 200, surrounds the outer strength members 270, and is formed through an extrusion process. The second sheath 280 is made of a plastic material, e.g., polyethylene (PE) or ethylene vinylacetate copolymer (EVA), and preferably, a low smoke zero halogen (LSZH) material having an ultraviolet (UV) protection function.

If the slot type optical cable 200 is installed in an area having no electrical danger area, it is preferable that the CSM 210, the first and second supporting members 240 and 245, and the outer strength members 270 are made of metallic materials. If the slot type optical cable 200 is installed in an electrical danger area, it is preferable that the CSM 210 and the first and second supporting members 240 and 245 are made of non-metallic materials and the outer strength members 270 are made of a metallic material.

FIG. 3 shows a method of securing insulation when the slot type optical cable 200 is installed in an electrical danger area. Here, only the outer strength members 270 are made of metallic materials and the other components of the slot type optical cable 200 are made of non-metallic materials. The end of the slot type optical cable 200 is connected to a connection enclosure 320. During for the connection process, the second sheath 280 and the outer strength members 270 of the slot type optical cable 200 located adjacent to the connection enclosure 320 are removed, then the removed portions are wound by a protecting member 310 made of a non-metallic material such as thermo-shrinkable plastic.

As described above, since a slot type optical cable according to the present invention includes supporting members that support the opposite inner walls of slot, deformation of the slots can be prevented when external pressure is applied to a core, thereby providing high compression resistance to the slot type optical cable.

While the invention has been shown and described with reference to a certain preferred embodiment thereof, it will be understood by those skilled in the art that various changes in form and details may be made therein without departing from the spirit and scope of the invention.

What is claimed is:

1. An optical cable comprising:
a core having a opening at its center and at least one slot at its circumference;
a central strength member inserted into the opening;
at least one light transmission medium arranged inside the slot;
at least one supporting member, at least a portion of which is arranged inside the slot to support inner walls of the slot that are located at opposite ends of each other; and
a first sheath surrounding the core.

2. The optical cable of claim 1, further comprising:
a plurality of outer strength members arranged around the first sheath to provide tensile strength; and
a second sheath, located in an outermost part of the optical cable, for surrounding the outer strength members.

3. The optical cable of claim 1, further comprising a water swellable member filled in a hollow internal space of the slot.

4. The optical cable of claim 2, wherein the second sheath is made of a low smoke zero halogen (LSZH) having a ultraviolet (UV) protection function.

5. The optical cable of claim 1, wherein the slot has a 2-layer structure in which a first layer is formed to have first predetermined depth and width towards the center of the core from the circumference of the core, and a second layer is formed to have second predetermined depth and width towards the center of the core from the bottom surface of the first layer.

6. The optical cable of claim 5, wherein the supporting member takes the form of a square block and is inserted between the opposite inner walls of the first layer of the slot.

7. The optical cable of claim 5, wherein the width of the second layer is substantially smaller than the first layer and the depth of the second layer is substantially larger than the first layer.

8. The optical cable of claim 5, wherein the first layer is in the form of a rectangular groove and the second layer in the form of a trapezoidal groove.

9. The optical cable of claim 1, wherein the core is made of a non-metallic material including polyvinyl chloride (PVC), polyvinylidene fluoride (PVDF), and fiber-reinforced plastic(FRP).

10. The optical cable of claim 1, wherein the central strength member is made of a metallic material including aluminum or made of a non-metallic material including fiber-reinforced plastic (FRP).

11. The optical cable of claim 1, further comprising a tube disposed on the slot for housing the light transmission medium.

12. The optical cable of claim 11, further comprising a jelly compound filled inside the tube to block moisture penetrated therein.

13. The optical cable of claim 1, wherein the transmission medium comprises a plurality of optical fibers,

14. The optical cable of claim 1, wherein the transmission media comprises optical fiber ribbons.

15. The optical cable of claim 1, wherein the tube comprises a non-metallic material including polycarbonate (PC).

16. The optical cable of claim 1, wherein the supporting member comprises a metallic material including aluminum or a non-metallic material including PVC.

17. The optical cable of claim 1, wherein the first sheath is made of a plastic material including polyethylene (PE) or ethylene vinylacetate copolymer (EVA).

18. The optical cable of claim 2, the outer strength members are arranged around the first sheath in the form of a straight line, or is wound around the first sheath spirally or using an S-Z winding method.

19. The optical cable of claim 2, the second sheath is made of a plastic material, including polyethylene (PE) or ethylene vinylacetate copolymer (EVA).
